(19) United States
(12) Patent Application Publication
(10) Pub. No.: US 2024/0211653 A1
(43) Pub. Date: Jun. 27, 2024

(54) VERIFICATION OF MODEL-BASED SYSTEMS ENGINEERING ARTIFACTS

(71) Applicant: Siemens Industry Software Inc., Plano, TX (US)

(72) Inventors: Gabor Schulz, Fürth (DE); Martin Richard Neuhäusser, Nürnberg (DE); Karen Ryan, Shoreview, MN (US)

(21) Appl. No.: 18/555,845

(22) PCT Filed: Apr. 29, 2021
(86) PCT No.: PCT/US2021/029873

§ 371 Date: Oct. 17, 2023

(51) Int. Cl. G06F 30/20; G06F 111/04; G06F 111/10

(52) U.S. Cl. CPC G06F 30/20; G06F 2111/04; G06F 2111/10

(57) ABSTRACT

A method of verifying a model-based system engineering (MBSE) artifact includes translating, by a translator implemented in software, the MBSE artifact into formulas of a first-order logic. The method further includes checking, by a solver executing a decision procedure implemented in software and operating on the formulas of the first order logic, whether or not a conjunction of the formulas is satisfiable.

The present patent document is a § 371 nationalization of PCT Application Serial No. PCT/US2021/029873, filed Apr. 29, 2021, designating the United States, which is incorporated by reference in its entirety.

### TECHNICAL FIELD

The present disclosure relates to model-based systems engineering. Systems engineering falls into the mechatronic engineering field. Mechatronic engineering is an interdisciplinary branch of engineering that focuses on the engineering of electronic, electrical, and mechanical engineering systems, which may include a combination of robotics, electronics, computer, telecommunications, systems, control, and/or product engineering.

### BACKGROUND

Model-based systems engineering (MBSE) involves the application of computer-based modeling to support activities related to the system requirements, design, analysis, verification, and validation of a system over the life cycle of the system. A variety of tools may be used to support the generation of MBSE models for the system and the links between these MBSE models.

For example, in US patent application publication US 20180357358 A1, a method for synchronizing the design, the analysis, and the product management of a product is proposed in order to improve the design and manufacturing of the product. Further on, US patent application publication US 20140092088 A1 proposes a three-dimensional view that includes a plurality of systems engineering models.

To address the challenge of engineering complex technical systems, (e.g., airplanes, trains, trucks, cranes, etc.), a model-based system engineering approach, (e.g., Capella, SysML, and Alloy), has gained widespread attention. The underlying modeling paradigms allow the user to decompose the system according to different aspects of the overall system architecture. For example, a system may be decomposed logically, (e.g., which blocks co-operate to achieve a given functionality), but also according to its physical composition. The common modelling frameworks are graphical, e.g., any such view on the system may be visualized using block diagrams where blocks are connected via ports and lines that connect those ports. While this approach provides a high-level decomposition of the system according to different criteria, the models may remain informal and their actual meaning may become clear by natural language annotations at the modeling constructs (e.g., blocks, ports, connecting lines). The organizations driving all major MBSE paradigms acknowledge the need for more formal specification within those models as witnessed by a variety of proposals to extend the underlying standards. However, no satisfying solution has been provided so far.

The MBSE model may be given by one or more MBSE artifacts. This approach however suffers from a lack of precision, inconsistencies from one MBSE artifact to another, and difficulties in maintaining and reusing the information contained in the MBSE artifacts.

### SUMMARY

It is thus an object to guarantee that the MBSE model(s) is sensible, reflects physical laws, or at least conforms to the most important requirements. It is a further object to enable a rigorous debugging and analysis of one or more MBSE artifacts since the correctness of the one or more MBSE models cannot be guaranteed without a rigorous automatic analysis.

The scope of the present disclosure is defined solely by the appended claims and is not affected to any degree by the statements within this summary. The present embodiments may obviate one or more of the drawbacks or limitations in the related art.

According to a first aspect, the object is achieved by a method of verifying a model-based system engineering (MBSE) artifact. The method includes translating, (e.g., by a translator implemented in software), the MBSE artifact into formulas of a first-order logic. The method further includes checking, (e.g., by a solver executing a decision procedure implemented in software and operating on the formulas of the first order logic), whether or not a conjunction of the formulas is satisfiable.

According to a second aspect, the object is achieved by a computer program, e.g., stored on least one non-transitory machine-readable medium. The computer program containing instructions that, when executed on a computing platform, cause the computing platform to perform the method acts according to the first aspect. The computing platform may include processing circuitry for executing the instructions of the computer program.

According to a third aspect the object is achieved by a computing platform. The computing platform includes at least one processor for performing the method acts according to the first aspect. The processor may include processing circuitry for performing the method acts according to the first aspect.

### BRIEF DESCRIPTION OF THE DRAWINGS

FIG. 1 depicts an example of an MBSE artifact modelling a real world technical system.

FIG. 2 depicts an example of a camera and corresponding MBSE artifacts modeling the camera.

FIG. 3 depicts a more detailed example of MBSE model of a camera including a plurality of MBSE artifacts.

FIG. 4 depicts exemplary method acts according to a first embodiment.

FIG. 5 depicts an example of software modules for translating and checking of MBSE artifacts.

FIG. 6 illustrates an example of a translation of a first modeling language into a second modeling language.

FIG. 7 depicts exemplary method acts according to a second embodiment.

FIG. 8 depicts exemplary method acts according to a third embodiment.

FIG. 9 illustrates an example of a creation of formulas of first order logic based on multiple MBSE artifacts.

FIG. 10 depicts exemplary method acts according to a fourth embodiment.

FIG. 11 depicts an example of a computer program for verifying MBSE artifacts.

### DETAILED DESCRIPTION

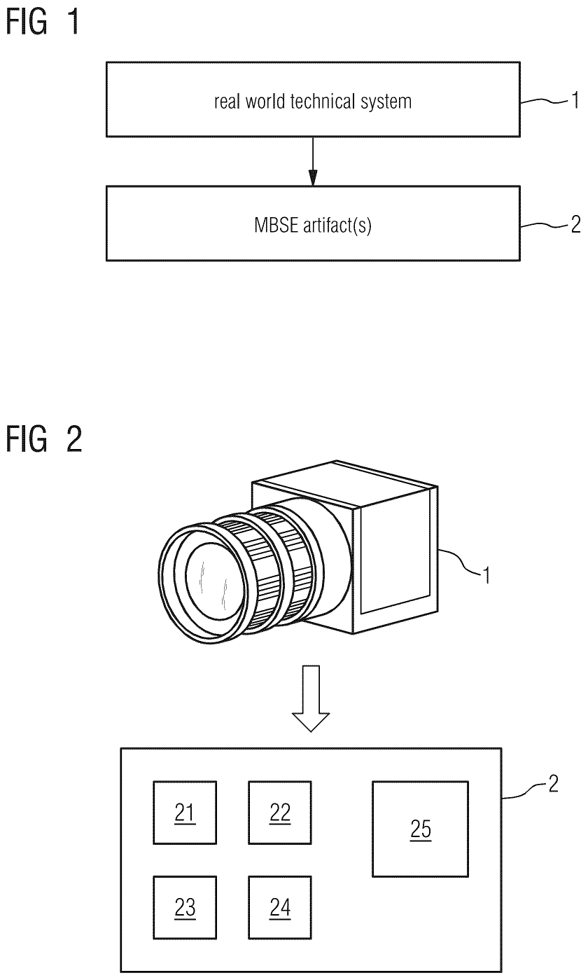

FIG. 1 shows an MBSE artifact 2 modeling a real world technical system 1. Model-based systems engineering (MBSE) involves the application of computer-based modeling of a real world technical system 1. To that end, the real world technical system 1 is modeled using a modeling language. As a result, one or more MBSE artifacts 2 may be created that include a model of the real world technical system 1. The MBSE artifact 2 may take the form of a file in a file format, e.g., in XML Metadata Interchange (XMI) format. Other examples of MBSE artifacts 2 include model files, source files, scripts, binary executable files, or a table in a database system.

For example, Systems Modeling Language (SysML) may be used as a modeling language. SysML supports the specification, analysis, design, verification, and validation of a real world system 1. The system 1 may be modeled using multiple interdependent MBSE artifacts 2. Therein each model and corresponding MBSE artifact 2 may be used to model different requirements and/or constraints of the system 1. Furthermore, the MBSE models may include the structure and function, as well as the organization of components of the system 1. For example, each MBSE artifact 2 may include a model of one or more components of the system 1. This component may be a physical component, a conceptual component, a functional component, or some other type of component. Each component may be associated with one or more properties or requirements. The MBSE artifact(s) 2 may be stored on a storage medium. For example, the storage medium may be a database or other type of memory. The MBSE artifact(s) 2 may thus be a digital model, document, database, diagram, or the like, which is created and managed in connection with a real world technical system 1, e.g., a product. For example, the system 1 may be an aircraft, a ship, a spacecraft, a watercraft, an engine system, a mechanical device, a composite structure, a vehicle frame, a computer network, or some other type of product. Non-limiting examples of products include articles of manufacture, prototypes, software products, software-as-a-service, and the like. Notably, in the development phase of a product, MBSE may provide an important framework for such quality controls as providing that design requirements are met, and that the performance and reliability of each use case of the product is proven through carrying out of a corresponding verification. Verification is the evaluation of whether or not a product, service, or system complies with a regulation, requirement, specification, or imposed condition. Verification may include checking whether a safety property is able to reach a given set of states.

FIG. 2 shows a camera and corresponding MBSE artifacts 22, 23, 24, 25. For exemplary purposes, a camera is considered as a real world technical system to be modeled, however another product may be used. The camera 1 may include multiple components with respective properties as described in the above. Each component and/or property may be described by an MBSE artifact 21, 22, 23, 24, 25. The entirety of the MBSE artifacts 21, 22, 23, 24, 25 may be interdependent and may be used to model the camera 1.

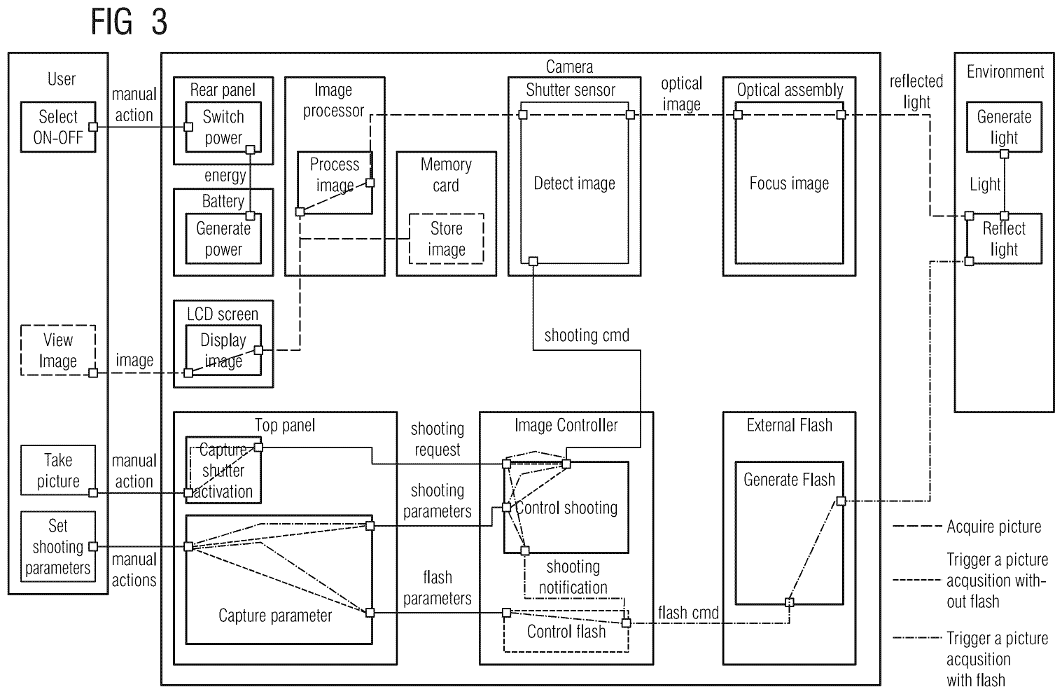

FIG. 3 shows a more detailed MBSE model of a camera including a plurality of MBSE artifacts. The camera may be decomposed into MBSE artifacts specifying different logical components. For example, a first MBSE artifact may specify the properties of a shutter sensor and a second MBSE artifact may specify the properties of the optical assembly. Further MBSE artifacts may specify the properties of a flashlight, an image controller, a top panel, an image processor, a memory card, a battery, an LCD screen, etc. For the modeling one or modeling software tools, such as the Capella, a MBSE tool may be used, which provides tooling for graphical modeling of systems. Therein, the function blocks of the components may be connected using function chains. The individual components and corresponding MBSE models of the camera may be provided by different suppliers. Dependent on the supplier the parameters of the function block may change. For example, different shutter sensor suppliers may support different shutter speeds. In addition, other parameters such as the focal length in the optical assembly and the near point calculation in the Top panel may be specified according to the desired requirement. Furthermore, function such as the flashlight and its angel of radiation may be set. Based on the parameters set, the depth of field may be calculated for the camera 1, e.g., using a solver executing a δ-complete decision procedure, as will be described in more detail later.

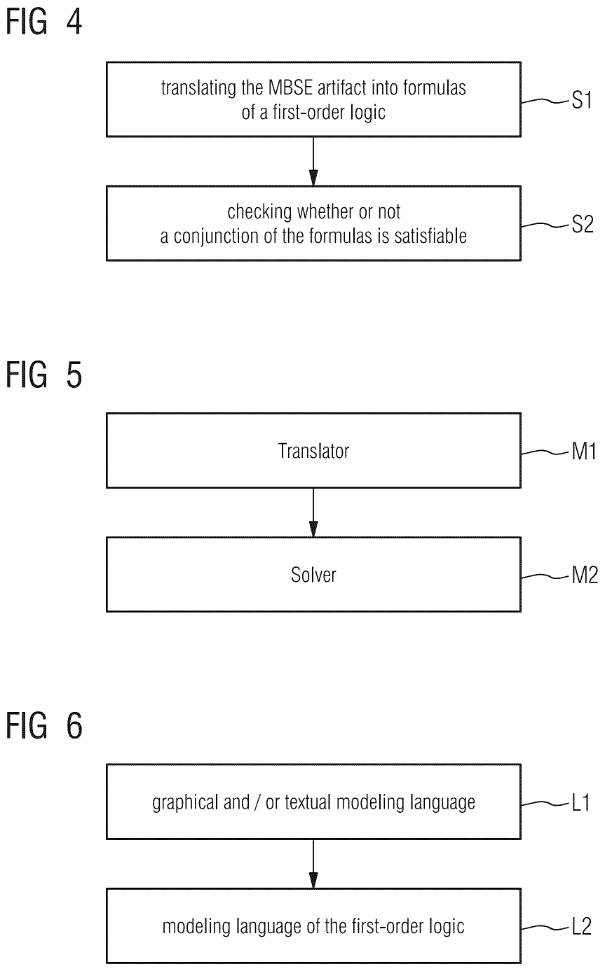

FIG. 4 shows exemplary methods acts according to a first embodiment. In act S1, one or more MBSE artifacts may be translated into formulas of a first order logic. Subsequently, in act S2, it may be checked whether or not a conjunction of the formulas is satisfiable. It is thus proposed to apply a theorem prover, also referred to as a solver, to verify the underlying MBSE model(s).

It is proposed to combine an MBSE approach with formal specifications, e.g., formulas. Moreover, the formal specifications are used to semantically analyze the models for different correctness properties. In this way, one may check automatically that one or more MBSE models are sensible. Moreover, having formal specifications and tools to automatically verify them enables a safe evolution of those MBSE models. Whenever an MBSE model (or one of its constituent components) is changed, the proposed methods and systems may automatically determine whether all correctness properties are still met.

In computer science, model checking is a method to validate the correctness of specifications (e.g., liveness or safety properties) of a given model. The practical applicability of model checking is strongly limited by the state explosion problem, which means that the number of model states grows exponentially in the size of the system representation. To avoid this problem, a number of state reduction techniques and symbolic model checking approaches have been developed, among others.

The SAT-based bounded model checking (BMC) is one of the symbolic model checking technique designed for finding witnesses for existential properties or counterexamples for universal properties. Its main idea is to consider a model reduced to a specific depth. The first BMC method was designed for linear time properties. The method has been extended to handle branching time properties.

The SMT problem is a generalization of the SAT problem, where Boolean variables are replaced by predicates from various background theories, such as linear, real and integer arithmetic. SMT generalizes SAT by adding equality reasoning, arithmetic, fixed-size bit-vectors, arrays, quantifiers, and other useful first-order theories. In order to use the bounded model checking method, a translation from a given, (e.g., temporal), logic to the satisfiability modulo theories problem (in short: to SMT) needs to be defined.

Bounded model checking with satisfiability solving has given promising results. The method may be applied to both safety and liveness properties, where the verification of a safety property involves checking whether a given set of states is reachable, and the verification of an eventuality property involves detecting loops in a system's state transition graph.

Models given as MBSE artifacts may be translated into predicate logic, e.g., using SMT-LIB. In addition, non-linear reasoning problems may be incorporated into the MBSE models using an SMT solver, e.g., dReal, able to cope with the non-linear mathematical fragment.

Thereby, the consistency of the MBSE model(s) may be checked and reasoned about inconsistencies in the MBSE model(s). Furthermore, a cross-model analysis may be provided. In addition, an impact analysis may be provided in case the models are changed. Still further, indirect or hidden dependencies may be detected and as mentioned, non-linear formulas may be considered.

A satisfiability modulo theories (SMT) problem is a decision problem for logical formulas that may be expressed in predicate logic. The classic logical problems may be enhanced with the combination of different background theories (e.g., linear integer arithmetic, linear rational arithmetic, or array theory). An SMT solver is a computer program that may be fed with predicate logic formulas and computes an answer to the given decision problem. SMT solvers come in different flavors, with specialization in different fields of mathematics (e.g., set theory or optimization). Such a solver is shown in FIG. 5.

FIG. 5 shows software modules, (e.g., a translator M1 and a solver M2), for performing one or more of the method acts proposed. In Barbau R., Bock C., “Verifying executability of SysML behavior models using Satisfiability Modulo Theory solvers,” NIST, 2020 a translation of MBSE structural elements as well as behavior model semantics (activities, state machines, and interactions) from SysML into SMT-LIB statements is described which is included here by way of reference. Therein, a SysML file in XMI format is input into a SysML to SMT-LIB translator, (cf. FIG. 5 of Barbau et al.). Subsequently, the SMT solver Z3 from Microsoft Research or the SMT solver dReal from Carnegie Mellon University may be chosen for checking whether or not a conjunction of the formulas is satisfiable. The source code is available for both of these SMT solvers, Z3 and dReal.

The translator M1 may translate one or more constraints implied by the underlying MBSE model into SMT-LIB modeling language in a straightforward way by using the SMT-LIB command “assert.” For example, the following constraints are obtained as SMT-LIB statements:

(declare-fun x ( ) Int)
(declare-fun y ( ) Int)
(assert (= y 2))
(assert (> (+ x 2) 0))
(assert (< x −2))
(check-sat)
(exit)

Execution of these statements by the solver M2 will simply give us the result “UNSAT.” The result “UNSAT” may be satisfactory for the purpose of model finding. However, the reasons why the model cannot be computed remain unclear.

The assert command instructs the solver to assume that the stated formula is true. The form of the command is (assert <expr>) in which <expr> is a properly constructed, well-sorted SMT-LIB expression, whose sort is Bool. An assert command may not appear before a set-logic command, since the logic is needed to provide the definitions of the sort and function symbols used in the expression.

An assert command responds with either: (1) success—in which case the new assertion is now part of the solver context; or (2) an error message—if the command is malformed, if the command is not well-sorted, (e.g. the sort of the whole expression is not Bool), if the command is misplaced (e.g., before a set-logic command), or if the expression is not allowed in the current logic.

The main purpose of a SMT solver is to check the satisfiability of a set of asserted expressions. Once a series of assert commands have been made, the check-sat command will instruct the solver to test for satisfiability. The command has a simple form: (check-sat). The command may respond with one of three responses.

One response may be “sat,” wherein the set of assertions is satisfiable. That is, there is a consistent set of assignments of values to constants and function symbols under which all asserted expressions are true. In this case, the get-assignment and get-value commands may be used to find out more about the satisfying assignment.

A second response may be “unsat,” wherein the set of assertions is unsatisfiable. That is, there is no set of assignments of values to constants and function symbols under which all asserted expressions are true. In this case, the get-proof and get-unsat-core commands may be used to find out more about the unsatisfiable assertions.

A third response may be “unknown,” wherein the solver cannot determine for sure whether the set of assertions is satisfiable or not. There may be various reasons for this. In some cases, the solver may have run out of memory or time. In others, the solver may have found a set of assignments that appears to make all asserted expressions true, but it cannot be sure because of the presence of quantified assertions. The reason-unknown info item may be used to ask for more information about why the solver responds with unknown. The command will respond with an error if there are any arguments to the command or the command precedes a set-logic command.

The SMT-LIB statements given in the above may be enhanced by introducing assumption literals in order to find a specific reason for the inconsistency and help the user in “debugging” the model, as for example shown in the following.

(set-option :produce-unsat-cores true)
(declare-fun a1 ( ) Bool)
(declare-fun a2 ( ) Bool)
(declare-fun a3 ( ) Bool)
(declare-fun x ( ) Int)
(declare-fun y ( ) Int)
(assert (=> a1 (= y 2)))
(assert (=> a2 (> (+ x 2) 0))
(assert (=> a3 (< x −2)
(check-sat a1 a2 a3)
(get-unsat-core)
(exit)

Here, the assumption literals a1, a2, a3 have been introduced all assertions. In addition, a UNSAT-core generation in the used SMT solver M2 has been activated in order to enable reasoning about model inconsistencies and bridge the gap from being a model finder to be able to reason about inconsistencies in MBSE models.

Assumptions are literals that are assumed to be true and are picked first for decisions during a single run.

A set of assumptions A is defined as a set of literals that are assumed to be true and which are picked for decisions first. Then, if during the search, it is needed to flip the assignment of one of these assumptions to false, the problem is unsatisfiable under the initial assumptions.

When an assumption literal is used for activating/deactivating a clause (one fresh assumption for each clause), it is called a selector for this clause. If the literal is false (resp. true) under the current assumptions, then the clause is activated (resp. deactivated). Therefore, since these additional literals appear only positively in the formula, the learned clauses obtained during the search process keep track of all the initial clauses used to produce them. Then, removing the set of clauses which are derived from an initial clause with selector a may be easily performed by simply assuming a to true.

An unsatisfiable core is a set of formulas for which no satisfying instance exists. An unsat core may be used to detect potential inconsistencies in a specification (for run command) or check whether an assertion holds vacuously true (for check).

A theory (also called a formal theory) is a set of sentences, (e.g., formulas), in a formal language. First the Boolean variables a1, a2, a3 need to be declared. The SMT-LIB syntax offers the command declare-fun for declaring functions, (e.g., mappings from some sequence of function arguments to the domain of the function), to obtain two Boolean variables named a1, a2 and a3. Constraints may thus be given to the SMT solver using the command assert.

After all constraints are passed to the solver M2, satisfiability of the constraint system may be checked by issuing the following command: (check-sat). The solver will reply to this command with unsat or sat, respectively.

The SMT-LIB format standardizes syntax for arithmetic over integers and over reals. The type of the variable is also called the sort. The SMT-LIB syntax has a few constructs that may be used for all sorts. For instance, one may write (=x y) to denote equality of x and y, provided that x and y have the same sort. Many of the operators may be chained, with the meaning, as in, for example, (+x y z). Thus, the expression 2x+y is written as (+(*2x)y).

Recent SAT solvers are incremental, i.e., they are able to check the satisfiability of a formula “under assumptions” and are able to output a core (a “reason” for the unsatisfiability of the formula).

The unsatisfiable core is defined as follows: (Unsatisfiable Core under Assumptions). Let φ be a satisfiable formula in a conjunctive normal form (CNF) built using Boolean variables. Let A be a consistent set of literals built using Boolean variables from a set of propositional variable such that (φ∧ [symbol] ) is unsatisfiable. C⊆A is an unsatisfiable core (UNSAT core) of φ under assumptions A if and only if (φ∧ [symbol] ) is unsatisfiable.

By introducing the assumption literals, the MBSE model checking capabilities are enhanced since by exploiting the UNSAT-core, which enables pinpointing assertions leading to inconsistencies in the underlying model.

Using the MBSE model to SMT-LIB translation and the UNSAT-core enhancement described above, it is possible to combine several MBSE models, e.g., from various sources like Teamcenter, Capella, or any other source supported. Thereby, a single MBSE artifact may be created by merging the original MBSE artifacts.

Furthermore, computations are not unusual in MBSE models and may contain trigonometric and other non-linear calculations. Reasoning about non-linearities is, in general, a problem in computer science. The heavy-weight industrial solvers like CPLEX and Gurobi are solvers for problems of the linear mathematical fragment only. It is thus proposed to use the SMT solver dReal as the underlying SMT solver for MBSE model checking. Basis for this solver is a paper describing δ-sat computation techniques laid out in Sicun Gao, Jeremy Avigad, and Edmund M. Clarke, “δ-Complete Decision Procedures for Satisfiability over the Reals,” Carnegie Mellon, 2012. Basically, the solver M2, (e.g., dReal), is an automated reasoning tool over the real numbers in the linear and non-linear fragment computing results up to a given precision (e.g., 10⁻³). In contrast to other solvers in the field doing computations with arbitrary precision, the solver provides several advantages: (1) non-linearities may be introduced into the MBSE models; (2) time and space of the computations needed to verify a model may be limited; and (3) the ability to do optimizations in the non-linear fragment a solver such as dReal supports non-linear optimization. A solver M2 like dReal may further be enhanced by implementing a UNSAT-core as dReal is open-source. For example, the following (e.g., non-linear) functions are ready to use in dReal: exp, log, sin, cos, tan, asin, acos, atan, atan 2, sinh, cosh, pow. Thus, the SMT-LIB statements may be extended for real numbers by non-linear functions in the following way:

theory Reals
:sorts ((Real 0))
:funs ((NUMERAL Real)
(DECIMAL Real)
(− Real Real)
(− Real Real Real :left-assoc)
(+ Real Real Real :left-assoc)
(* Real Real Real :left-assoc)
(/ Real Real Real :left-assoc)
(exp Real Real :left-assoc) ;new dReal operator
(log Real Real :left-assoc) ;new dReal operator
(sin Real Real :left-assoc) ;new dReal operator
(cos Real Real :left-assoc) ;new dReal operator
(tan Real Real :left-assoc) ;new dReal operator
(asin Real Real :left-assoc) ;new dReal operator
(acos Real Real :left-assoc) ;new dReal operator
(atan Real Real :left-assoc) ;new dReal operator
(atan2 Real Real :left-assoc) ;new dReal operator
(sinh Real Real :left-assoc) ;new dReal operator
(cosh Real Real :left-assoc) ;new dReal operator
(pow Real Real Real :left-assoc) ;new dReal operator
(<= Real Real Bool :chainable)
(< Real Real Bool :chainable)
(>= Real Real Bool :chainable)
(> Real Real Bool :chainable)
)

In addition to the changes in SMT-LIB, the translator M1 is extended appropriately to reflect the additions in SMT-LIB and supports the translation of non-linear formulas from given MBSE models into the solver. Such formula parsing into SMT-LIB and back from SMT-LIB is exhaustively handled and with many approaches as well as for many programming languages known, (cf., the parsers provided by http://smtlib.cs.uiowa.edu/utilities.shtml).

The proposed solution allows to prove that a MBSE model adheres to a specification, (e.g., a requirement, a consistency condition, completeness conditions), even taking non-linear mathematical formulas into account. To achieve this, it is proposed to formalize requirements and engineering MBSE artifacts in first order logic and apply theorem provers, (e.g., solver M2), to establish correctness properties even when non-linear formulas are part of the problem.

FIG. 6 illustrates the translation of a first modeling language L1 into a second modeling language L2.

As mentioned, a system may be modeled by several MBSE artifacts. For example, two or more MBSE models may be provided, (e.g., given in the form of MBSE artifacts from different sources that are not related). Each model may be translated into formulas of a first order logic. Optionally, the well-formedness of each individual MBSE model may be checked by the solver. Then, different function blocks of the MBSE models may be related to each other, e.g., by connecting the inputs and outputs of the different MBSE models, e.g., made interdependent. If the connected or interdependent MBSE models are inconsistent, it is possible to reason about the inconsistent constraint(s) and find the one or more assertions that made the MBSE model inconsistent. Thereby, it may be checked whether the overall MBSE model (e.g., including the MBSE models or sub-models), its behavior, and additional constraints are valid. If one or more of the MBSE models are inconsistent, it may be reasoned by the solver why the overall model is not well-formed and therefor inconsistent and invalid.

The MBSE artifacts may be created using a first modeling language L1. The first modeling language L1 may be a graphical and/or textual modeling language, such as SysML. As the case may be, multiple MBSE artifacts in different modeling language may be provided, e.g., from different vendors. Now the one or more MBSE artifacts may be translated into a second modeling language L2, e.g., a first order logic. As the case may be, several MBSE artifacts may be merged into a single MBSE artifact by way of the translation. Alternatively, each MBSE artifact may first be translated individually and then merged into a single MBSE artifact of first order logic as the case may be. Thus, the multitude of MBSE artifacts are translated into one or more formulas of first order logic. Subsequently, the conjunction of formulas of first order logic may be checked by a solver, as described above.

Additionally, or alternatively, a first MBSE model with interfaces to a second MBSE model and/or third MBSE model implemented by different vendors may be provided. By translating the second and/or third model into the formulas of the first order logic, it is possible to prove that the second and/or third model conform to the requirements or give reasons why they don't.

Considering the case when one or more connected or interdependent MBSE artifacts are changed or updated, it is also possible to enumerate the respective instances of the changed or updated MBSE artifacts. Hence, it is possible to determine which instances of a first MBSE artifact or a second MBSE artifact are lost and identify why those instances went inconsistent.

Considering a first MBSE artifact and a second MBSE artifact that are developed independently, but in accordance with a third MBSE artifact, one or more further MBSE artifacts, (e.g., of another vendor), may be checked for conformity and problems in relation to the given first, second, and/or third MBSE artifacts.

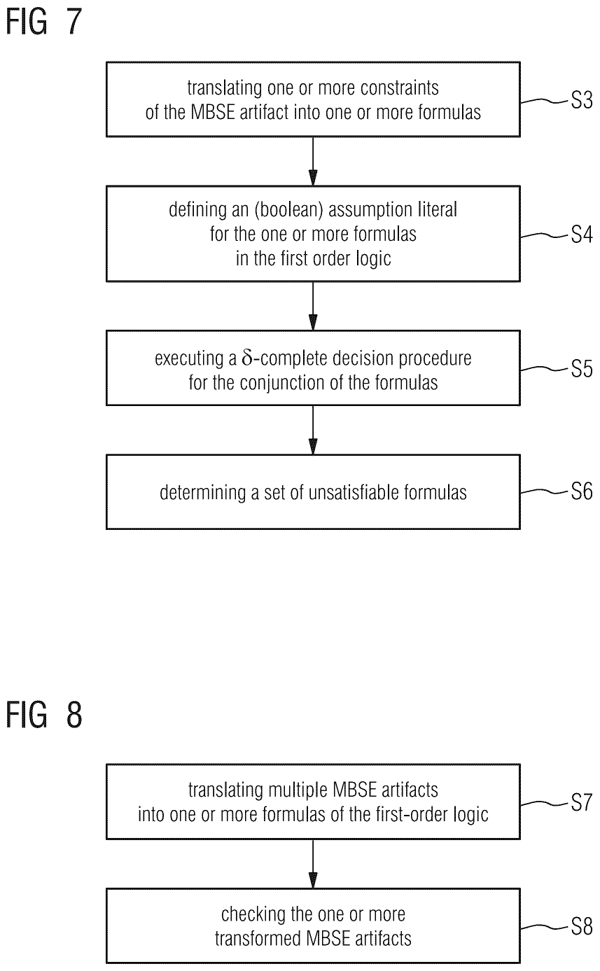

FIG. 7 shows exemplary methods acts according to a second embodiment. In act S3, one or more constraints of the MBSE artifact may be translated into one or more formulas of first order logic. Subsequently, in act S4, a Boolean assumption literal may be defined for the one or more formulas in the first order logic. An example of which has been provided in connection with FIG. 5. Then, in act S5, a δ-complete decision procedure for the conjunction of the formulas may be executed by a s solver. In act S6, the solver may provide parameter values that satisfy the constraints provided by the MBSE models described in the MBSE artifact or in case the constraints are not satisfiable the solver may determine one or more unsatisfiable formulas, (e.g., a set of unsatisfiable formulas). Thereby, the constraints of the MBSE model or respective MBSE artifact may be identified, which lead to the inconsistency. As a consequence, the MBSE model or the respective parameter values and ranges in the MBSE artifact may be adapted. Moreover, one or more components of the real world technical system may need to be exchanged in order to make the system function in accordance with the desired behavior.

FIG. 8 shows exemplary methods acts according to a third embodiment. As described previously, in act S7, multiple MBSE artifacts may be translated into one or more formulas of the first-order logic. Thus, an overall MBSE model established from several interdependent MBSE artifacts may be verified. A translator implemented in software may translate the interdependent MBSE artifacts into formulas of a first-order logic. Subsequently, in act S8, a solver executing a decision procedure implemented in software and operating on the formulas of the first order logic may check whether or not a conjunction of the formulas is satisfiable. The act of checking may include executing, by the solver, a δ-complete decision procedure for the conjunction of the formulas including non-linear and/or trigonometrical functions. Alternatively, other suitable decision procedures in the SMT-LIB domain instead of the complete decision procedure may be used.

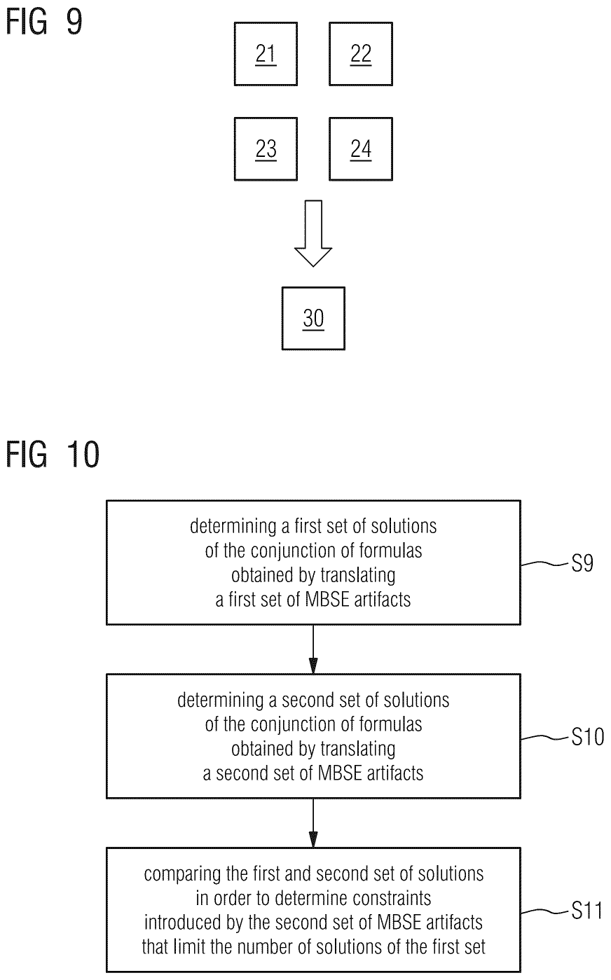

FIG. 9 illustrates the creation of formulas of first order logic based on multiple MBSE artifacts 21, 22, 23, 24. As explained, multiple MBSE artifacts may be merged and a translation of the MBSE artifacts in first order logic may be obtained. The translation may be provided as a set of formulas. The formulas may be stored on a storage medium, e.g., as a file 30 in a certain format, e.g., XMI. For example, the storage medium may be a database or other type of memory.

FIG. 10 shows exemplary methods acts according to a fourth embodiment. Now, the change or update of one or more MBSE artifacts are considered. Hence, a first and a second version of an MBSE artifact may exist. Furthermore, an MBSE artifact may be exchanged, for example, because a component of another vendor is used and thus the MBSE artifact is exchanged as well. As a consequence, in act S9, a first set of solutions of the conjunction of formulas obtained by translating a first set of MBSE artifacts may be determined. In certain examples, in act S10, after the update, change, or exchange of one or more MBSE artifacts, a second set of solutions of the conjunction of formulas obtained by translating a second set of MBSE artifacts may be determined. Then, in act S11, the first and second set of solutions may be compared in order to determine constraints introduced by the second set of MBSE artifacts that limit the number of solutions of the first set. Thereby, it is possible to backtrack inconsistencies and to identify the constrains introduced by the one or more MBSE artifacts.

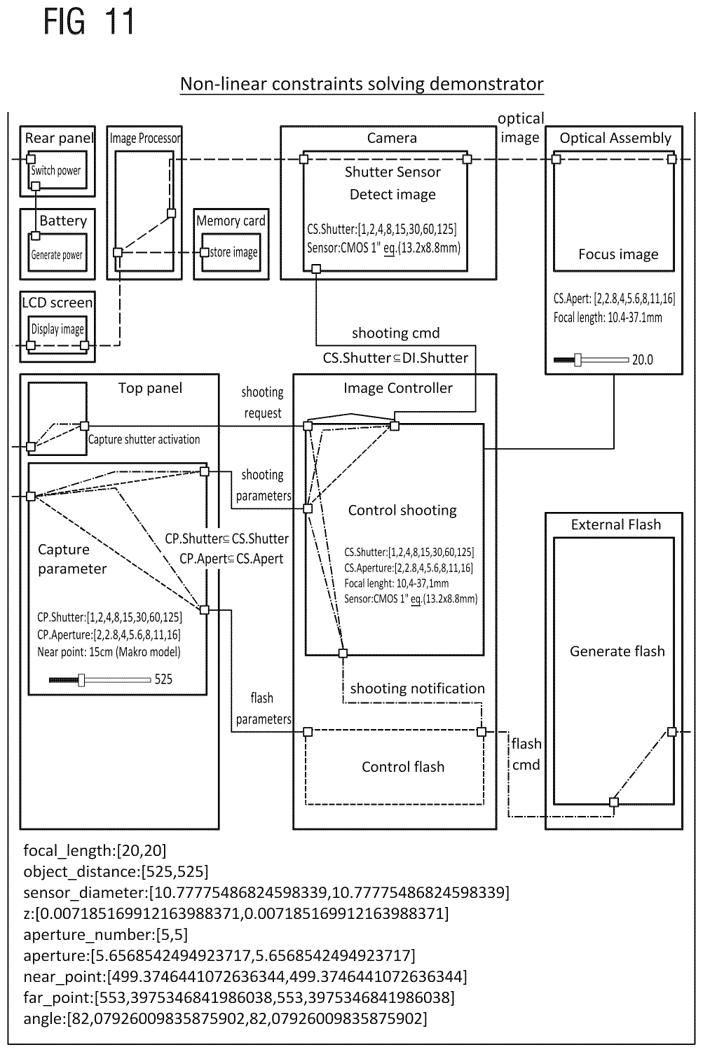

FIG. 11 shows a graphical interface of a computer program for verifying model-based system engineering, MBSE, artifacts. Returning to the example of the camera shown and described in connection with FIG. 3, the solver implemented in software as a computer program may be used to determine the near and the far point of the camera 1 according to its MBSE model. As may be seen, for a configuration with the flashlight turned on, the output of the solver is given as a range with the specified precision, e.g., according to a δ-complete decision procedure, such as using the solver dReal.

If the near point is set to 225 mm instead of 525 mm, e.g., using the slider of the Top panel function block, the solver is able to output that the flashlight in its current setting of a radiation angle of 30 degrees cannot satisfy this requirement. Thus, either the flashlight needs to be turned off or the radiation angle needs to be set to a wider angle, e.g., 45 degrees, in order to make the MBSE model consistent again.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method of verifying a model-based system engineering (MBSE) artifact, the method comprising:
translating, by a translator implemented in software, the MBSE artifact into formulas of a first-order logic; and
checking, by a solver executing a decision procedure implemented in software and operating on the formulas of the first-order logic, whether or not a conjunction of the formulas is satisfiable.

2. The method of claim 1, wherein the translating comprises translating the MBSE artifact from a first, graphical and/or textual, modeling language into a textual modeling language of the first-order logic.

3. The method of claim 1, wherein the MBSE artifact comprises non-linear functions, and
wherein the translating comprises translating the non-linear functions of the MBSE artifact into corresponding expressions of the formulas in the first-order logic.

4. The method of claim 3, wherein the checking comprises executing, by the solver, a δ-complete decision procedure for the conjunction of the formulas.

5. The method of claim 1, wherein the translating comprises translating one or more constraints of the MBSE artifact into one or more of the formulas.

6. The method of claim 1, wherein the translating further comprises defining an assumption literal for the one or more formulas in the first order logic.

7. The method of claim 1, wherein the translating comprises defining an assumption literal for each one of the formulas.

8. The method of claim 1, wherein the checking comprises determining, by the solver, a set of unsatisfiable formulas.

9. The method of claim 1, wherein the translating comprises translating multiple MBSE artifacts into one or more formulas of the first-order logic, therein creating one or more transformed MBSE artifacts in the first-order logic, and
wherein the checking comprises checking the one or more transformed MBSE artifacts.

10. The method of claim 1, wherein the checking comprises:
determining, by the solver, a first set of solutions of the conjunction of formulas obtained by translating a first set of MBSE artifacts;
determining, by the solver, a second set of solutions of the conjunction of formulas obtained by translating a second set of MBSE artifacts, the second set of MBSE artifacts comprising the first set of MBSE artifacts; and
comparing the first set of solutions and the second set of solutions in order to determine constraints introduced by the second set of MBSE artifacts that limit a number of solutions of the first set.

11. A computer program stored on least one non-transitory machine-readable medium, the computer program containing instructions that, when executed on a computing platform, cause the computing platform to:
translate, by a translator, a model-based system engineering (MBSE) artifact into formulas of a first-order logic; and
check, by a solver executing a decision procedure implemented in software and operating on the formulas of the first order logic, whether or not a conjunction of the formulas is satisfiable.

12. A computing platform comprising:
at least one processor configured to:
translate a model-based system engineering (MBSE) artifact into formulas of a first-order logic; and
check whether or not a conjunction of the formulas is satisfiable.

13. The method of claim 2, wherein the first modeling language is SysML, and
wherein the textual modeling language of the first-order logic is SMT-LIB.

14. The method of claim 3, wherein the non-linear functions comprise one or more trigonometric functions.

15. The method of claim 6, wherein the assumption is a Boolean assumption.

16. The method of claim 7, wherein the assumption is a Boolean assumption.

17. The method of claim 8, wherein the set of unsatisfiable formulas comprises an unsatisfiable conjunction of the formulas.
